(19) United States
(12) Patent Application Publication
(10) Pub. No.: US 2010/0116287 A1
(43) Pub. Date: May 13, 2010

(54) System and apparatus for dental hygiene

(76) Inventor: Yaneav Cohen, Scottsdale, AZ (US)

Correspondence Address: TOD R NISSLE, PO BOX 55630, PHOENIX, AZ, 85078, US

(21) Appl. No.: 12/291,444

(22) Filed: Nov. 10, 2008

(51) Int. Cl. A61C 15/04

(52) U.S. Cl. 132/323

(57) ABSTRACT

A method to clean the interproximal mesial and distal surfaces of a pair of adjacent teeth, as well as to clean the outer surfaces of the teeth.

This invention relates to systems of dental hygiene, and for apparatus and methodology for accomplishing the same.

Dental floss, toothbrushes and other apparatus and methods for accomplishing dental hygiene have long been known.

However, as has been demonstrated many times in the Patent Office, existing apparatus and methods often can be improved by utilizing an unidentified, unanticipated combination which provides functions that are unpredictable in view of the prior art.

Accordingly, it would be highly desirable to provide an improved system to clean teeth and/or promote healthy gums.

Therefore, it is a principal object of the invention to provide an improved hygiene system and apparatus.

These and other, further and more specific objects and advantages of the invention are set forth below, in conjunction with the drawings, in which:

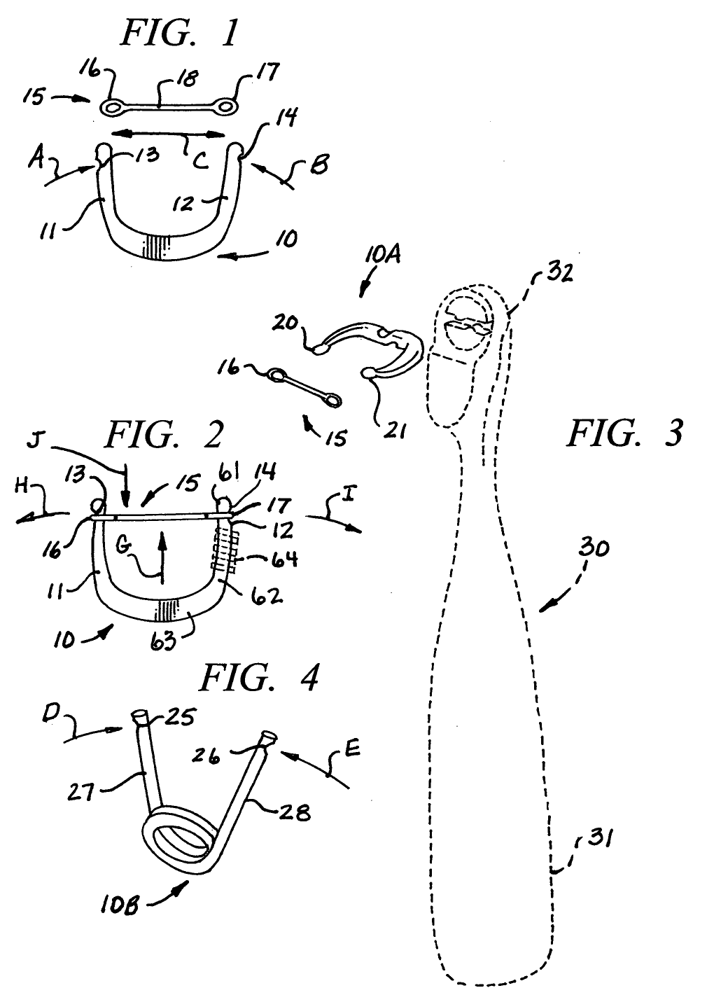

FIG. 1 is a front exploded view illustrating a dental cleaning tool constructed in accordance with the principles of the invention;

FIG. 2 is a front assembly view illustrating the dental cleaning tool of FIG. 1;

FIG. 3 is a perspective view illustrating a dental cleaning tool constructed in accordance with another embodiment of the invention;

FIG. 4 is a perspective view illustrating a dental cleaning tool constructed in accordance with still another embodiment of the invention;

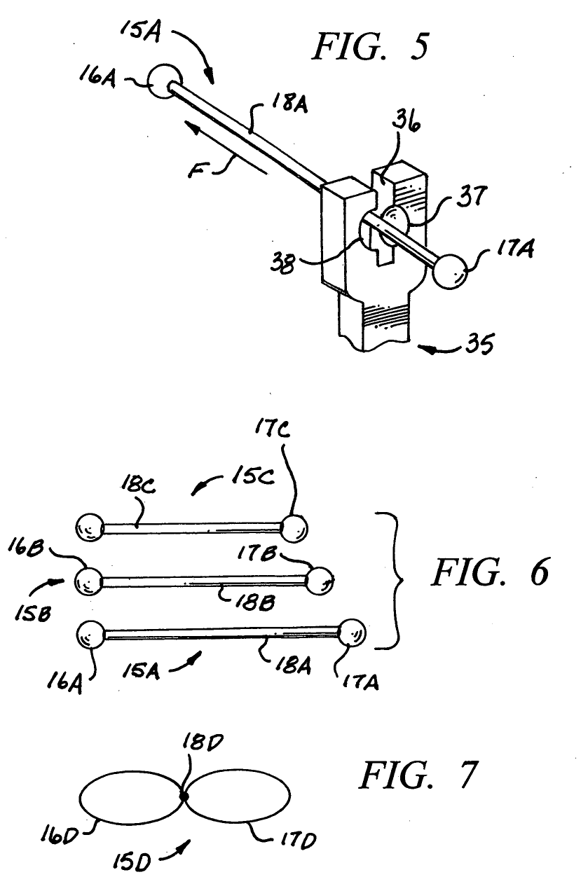

FIG. 5 is a perspective view illustrating a portion of a dental cleaning tool constructed in accordance with yet another embodiment of the invention;

FIG. 6 is a side view illustrating an assortment of dental floss units that can be utilized in conjunction with the embodiment of the invention of FIG. 5;

FIG. 7 is a top view illustrating a dental floss unit constructed in accordance with still a further embodiment of the invention;

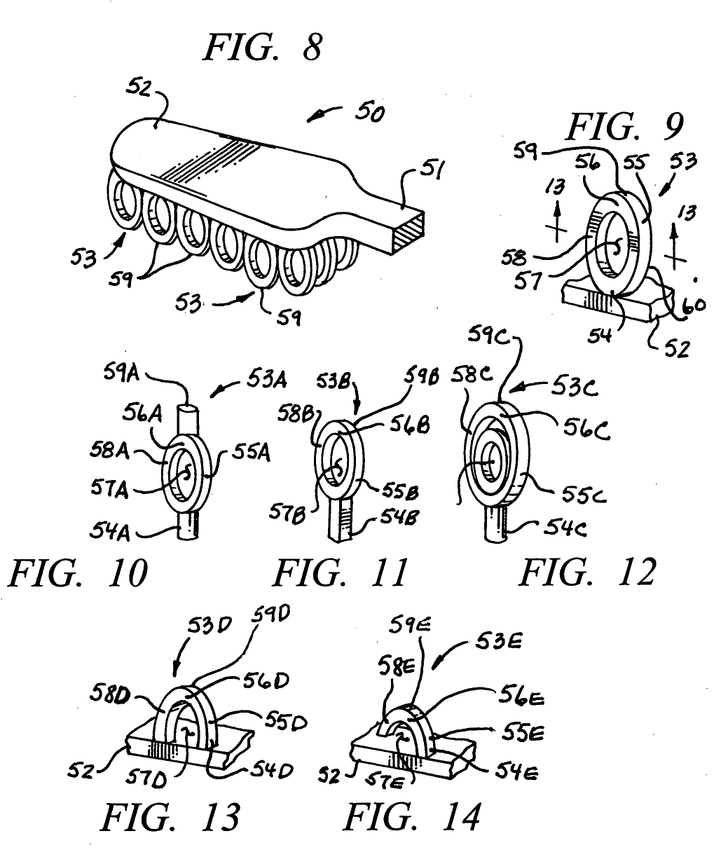

FIG. 8 is a perspective view illustrating a toothbrush constructed in accordance with another embodiment of the invention;

FIG. 9 is a perspective view of a bristle utilized in the toothbrush of FIG. 8 and illustrating further construction details thereof;

FIG. 10 is a perspective view illustrating another bristle that can be utilized in the toothbrush of FIG. 8;

FIG. 11 is a perspective view illustrating a further bristle that can be utilized in the toothbrush of FIG. 8;

FIG. 12 is a perspective view illustrating still a further bristle that can be utilized in the toothbrush of FIG. 8;

FIG. 13 is a perspective view illustrating still another bristle that can be utilized in the toothbrush of FIG. 8; and,

FIG. 14 is a perspective view illustrating yet a further bristle that can be utilized in the toothbrush of FIG. 8.

Briefly, in accordance with my invention, I provide an improved method to clean multiple surfaces, including for example the interproximal mesial and distal surfaces, of a pair of adjacent teeth. The method comprises the steps of providing at least two preformed disposable pieces of dental floss having a selected generally fixed length and a pair of ends; and, providing a dental cleaning tool including a handle and a reusable fork. The fork has at least a pair of resilient spaced apart arms. Each arm has a distal end with a detent formed therein to receive at least one of the ends of the dental floss. The end of each piece of the dental floss is shaped and dimensioned to seat removably in at least one of the detents. The arms are movable between at least two operative positions, a first untensioned position without one of the pieces of dental floss mounted on and extending therebetween, the distance between the arms in the first position being greater than the length of each of the pieces of dental floss; and, a second tensioned position with one of the pieces of dental floss mounted on the fork, with each of the ends of the one of the pieces of dental floss seated in a different one of the detents, and with at least one of the arms pulled toward the other by the one of the pieces of dental floss to tension the arms. The arms are also spaced apart a distance in the range of twelve mm to fifty mm in the second tensioned position; and, displaced toward each other a distance of at least three mm when a shear force in the range of fifty to two thousand grams is exerted against one of the pieces of dental floss after one of the pieces of dental floss is mounted on the fork and the legs in said second tensioned position. The method also includes the steps of moving the legs from the first untensioned position to the second tensioned position by mounting the first piece of dental floss on the legs of the fork with each end of the first piece seated in a different one of the detents; manually grasping the handle and manipulating said tool to move the first piece of dental floss mounted on the fork between the pair of adjacent teeth to generate a shear force in the range of fifty to two thousand grams to displace the arms toward each other a distance of at least three millimeters; removing the first piece of dental floss from the fork; mounting the second piece of dental floss on the legs of the fork with each end of the second piece of dental floss seated in a different one of said detents; and, manually grasping the handle and manipulating the second piece of dental floss over the interproximal mesial and distal surfaces of the pair of adjacent teeth. The first piece of dental floss can have a length different than said second piece of dental floss. The pieces of preformed dental floss can each be looped at either end and generally have the shape of a figure eight.

In another embodiment of the invention, I provide an improved method to clean teeth and gums. The method comprises the steps of providing a toothbrush including a handle, a head, and a plurality of resilient elongate bristles. Each bristle includes a proximate end fixedly attached to the head; a first portion extending upwardly in a first direction away from the proximate end and the head; and, a second fold portion. The second fold portion is connected to the first portion and loops to extend in a second direction opposed to the first direction and generally toward the proximate end and the head; and includes a downwardly extending leg. The leg is opposed to and spaced apart from the first portion; and, includes an outer tooth contacting surface. The first and second portions circumscribe at least in part an open space intermediate the first and second portions. The method includes the step of grasping the handle and contacting and brushing teeth and gums with the outer tooth contacting surfaces of the bristles.

Turning now to the drawings, which are presented by way of explanation and not limitation of the invention, and in which like reference characters refer to corresponding elements throughout the several views, FIG. 1 is an exploded view illustrating a dental tool 10 comprising a fork, and a piece of disposable preformed dental floss 15 that is mounted on the fork. The fork includes a base and a pair of upstanding resilient arms 11 and 12 depending from the base and having a distal end. Each arm 11 and 12 includes a detent 13 and 14, respectively, formed in the distal end thereof. The piece of dental floss 15 can, if desired, be elastic, but presently preferably is substantially non-elastic and resistant to being stretched. The length of the piece of dental floss 15 is less than the distance, indicated by arrows C, between the arms 11 and 12 when they are in the untensioned operative position illustrated in FIG. 1. Each end 16, 17 of the piece of dental floss 15 comprises a loop or is otherwise formed to seat in a detent formed in the distal ends of the arms 11 and 12 of tool 10.

When the piece of dental floss 15 is mounted on arms 11 and 12 with loops 16 and 17 seated in detents 13 and 14, respectively, in the manner illustrated in FIG. 2, the piece 15 functions to tension arms 11 and 12 by pulling them toward each other in the directions indicated by arrows A and B. Arms 11 and 12 can also be tensioned by utilizing an elastic piece of dental floss 15 that stretches, or lengthens, when it is mounted on arms 11 and 12.

The base of tool 10 can, after the piece of dental floss 15 is mounted thereon, be manually grasped and manipulate to move dental floss between the interproximal mesial and distal surface of a pair of adjacent teeth in order to move the central portion of said piece of dental floss over and clean said mesial and distal surfaces. However, tool 10 is presently preferably mounted—either permanently or removably—on a support member 30 that includes a head 32 and a handle 31. Support member 30 becomes an integral part of tool 10. The support member 30 can comprise a single, fixed, substantially rigid piece which requires a user to manually oscillate the member 30 to move the central portion 18 of the piece of dental floss over the surface of a tooth; can comprise a member with a motor or means to vibrate or move ultrasonically or otherwise the piece of dental floss 15; or, can comprise any other desired structure which holds and facilitates the movement and use of tool 10.

While tool 10 can be disposable, in an important embodiment of the invention, tool 10 is not disposable and is reused many times. Instead, the piece of dental floss 15 is disposable., and is removed from tool 10, discarded, and replaced with another comparable piece of dental floss. Tool 10 can be fabricated from any desired material, but is preferably fabricated from stainless steel or another metal or metal alloy or composition that facilitates elastically cleaning and disinfecting tool 10.

Another embodiment 10B of a fork tool constructed in accordance with the invention is illustrated in FIG. 4 and includes a pair of upstanding resilient arms 27 and 28 depending from a spring base and having a distal end. Each arm 27 and 28 includes a detent 25 and 26, respectively, formed in the distal end thereof. The piece of dental floss 15 can, as noted, be elastic, but presently preferably is substantially non-elastic and resistant to being stretched. The length of the piece of dental floss 15 is less than the distance between the arms 27 and 28 when they are in the untensioned operative position illustrated in FIG. 1. Each end 16, 17 of the piece of dental floss 15 comprises a loop or is otherwise formed to seat in a detent formed in the distal ends of the arms 27 and 28 of tool 10B.

When the piece of dental floss 15 is mounted on arms 27 and 28 with loops 16 and 17 seated in detents 25 and 26, respectively, in a manner similar to that illustrated in FIG. 2, the piece 15 functions to tension arms 27 and 28 by pulling them toward each other in the directions indicated by arrows D and E.

Still another embodiment of a fork tool constructed in accordance with the invention is illustrated in FIG. 5. In FIG. 5 only the distal end of a single resilient fork arm 35 is illustrated, with the understanding that (1) tool does, in a manner similar to tools 10 and 10b, include a second fork arm that is spaced apart from and of similar construction to arm 35 and (2) each fork arm is attached to and depends outwardly from a base.

A slot 36 is formed through the distal end of arm 35. Further a generally semispherical detent is formed in the distal end of arm 35 and faces outwardly in the manner illustrated in FIG. 5. The semispherical detent comprises a first quarter-spherical detent 38 and a second equivalent quarter-spherical detent 37. Quarter-spherical detents 37 and 38 are spaced apart by slot 36. When one end of a piece of dental floss 15A is mounted on the tool that is illustrated in part in FIG. 5, spherical end 17A seats in the detent formed in the distal end of arm 35; this while the other spherical end 16A of the piece of dental floss 15A seats in a like detent faces outwardly away from arm 35. The piece of dental floss 15A can, as noted, be elastic, but presently preferably is substantially non-elastic and resistant to being stretched. The length of the piece of dental floss 15A is less than the distance between the spaced apart arms 35 when they are in the untensioned operative position. Each end 16A, 17A of the piece of dental floss 15A is spherically shaped to seat in a detent formed in the distal ends of the arms 35. By way of example, and not limitation, ends 16A, 17A can comprise a polymer.

When the piece of dental floss 15A is mounted on arms 35 with ends 16A and 17A each seated in a pair of quarter-detents 37 and 38, the piece 15A functions to tension arms 35 by pulling them toward each other.

One method for varying the magnitude of the tensioning force applied to a pair of arms 11 and 12 by a piece of dental floss 15 mounted on the arms is to provide disposable preformed pieces of dental floss 15A, 15B, 15C of varying length (FIG. 6). Piece 15A includes ends 16A and 17A and central portion 18A. Piece 15B includes ends 16B and 17B and central portion 18A. Piece 15C includes ends 17C and central portion 18C.

Another method for varying the magnitude of the tensioning force applied to a piece of floss mounted on a pair of arms 11 and 12 is to construct each arm 11, 12 to vary the shear modulus or modulus of rigidity (G or μ) along the length of the arm. For example, if tool 10 is constructed from a nickel titanium alloy the shear modulus per unit volume of metal at the distal tip 61 of an arm 12 can be different from the shear modulus of metal per unit volume at the proximate end 62 of the arm 12. Accordingly, the resistance of arm 12 to being inwardly bent can vary along the length of an arm 12. Similarly, the resistance of arm 12 to being inwardly bent can be varied by varying the thickness of arm 12 along its length. If the distal tip 61 of arm 12 is thinner than portions of arm 12 that are beneath tip 61, distal tip 61 may be more readily inwardly bent than portions of arm 12 that are beneath tip 61. As the location along arm 12 approaches base 63, the resistance of arm 12 to being inwardly displaced in the direction of arrow B normally will increase because the base 63 is normal to arm 12 and therefore tends to be more resistant to being deformed. Resilient arms 11, 12 can comprise coiled springs 64. The shape and dimension of arms 11, 12 can vary as desired as long as arms 11, 12 are resilient.

A surprising and unexpected result of the invention is that it reduces the risk of injury to an individual's gums. If tool 10 is utilized to displace floss 15 inwardly (where inwardly indicates a direction between teeth and toward the gum line) in the direction of arrow G between a pair of teeth and toward the gum between the teeth, the floss often encounters a contact point at which the teeth are touching or are close enough together to resist the passage of the floss toward the gum. Such resistance generates a shear force that acts against the floss in the direction indicated by arrow J in FIG. 2.

When tool 10 is utilized to exert pressure inwardly on floss 15 in the direction of arrow G to force it past this contact point toward the gum line, the resisting shear force J causes arms 11 and 12 to be resiliently displaced inwardly in the direction of arrows A and B. As a result, a portion of the force G translates to resilient arms 11 and 12, and arms 11 and 12 exert in the directions indicated by arrows H and I in FIG. 2 increased tensile forces on floss 15. This tends to reduce the magnitude of force G being applied to floss 15 by tool 10.

If, as is generally the practice, the tool and floss are moved laterally back and forth to “work” the floss 15 past the contact point and toward the gum line, the magnitude of the forces H and I will vary. If tool 10 is moved laterally in a direction equivalent to the direction of tensile force H, the magnitude of the inward force A (FIG. 1) acting on arm 11 tends to increase and the magnitude of the inward force B acting on arm 12 tends to decrease. If tool 10 is moved laterally in a direction equivalent to the direction of tensile force 1, the magnitude of the inward force B (FIG. 1) acting on arm 12 tends to increase and the magnitude of the inward force A acting on arm 11 tends to decrease. This is because the frictional resistance of the teeth at the contact point opposes such lateral “back and forth” movement of the floss. During such lateral “back and forth” movement, one arm 11 of the fork is located on the inside (i.e., the tongue side) of the pair of teeth while the other arm 12 is located on the outside (i.e., the cheek side) of the pair of teeth.

The distance, indicated by arrows C in FIG. 1, between the distal tips of arms 11 and 12 after a length of floss 15 is mounted on the distal tips in the manner illustrated in FIG. 2, is in the range of twelve to fifty millimeters (mm), preferably fifteen to forty mm, and most preferably eighteen to thirty millimeters.

When tool 10 is being utilized to force inwardly in the direction of arrow G (FIG. 2) floss 15 past a contact point of a pair of adjacent teeth and toward the gum line in the manner described above, an opposing outwardly acting (where outwardly means away from the gum line) shear force acts, as noted above, on floss 15 in the direction indicated by arrow J in FIG. 2. Shear force J is generally normal to the longitudinal axis of the floss. This shear force J typically is, depending on the magnitude of force G, in the range of fifty to two thousand grams, preferably one hundred to fifteen hundred grams, and more preferably two hundred to one thousand grams. When such a shear force J is applied to floss 15 on tool 10, arms 11, 12 are inwardly deflected a combined distance of at least three mm, preferably four mm, and most preferably six mm. For example, if the distance, indicated by arrows C, between the distal tips of arms 11 and 12 is sixteen mm after a piece of floss 15 is mounted on the distal tips of arms 11 and 12, then when an inwardly acting force G in the range of fifty to two thousand grams is applied to floss to work floss 15 past a contact point, then arms 11 and 12 are inwardly deflected such that the distal between the distal ends of arms is no longer sixteen mm, but is thirteen mm, preferably twelve mm, and most preferably ten mm. Such elastic inward deflection of arms 11 and 12 evidences significant flexibility that is important in minimizing the likelihood that a user will force floss through the contact point, into the user's gum, and injure the gum.

Yet another configuration for a piece of preformed dental floss 15D is illustrated in FIG. 7 and includes loop ends 16D and 17D and central knot or overlap or tie portion 1 8D. Floss 15 D generally has the shape of a figure eight. A central overlap 18D can be formed by taking an oval piece of floss and twisting the ends of the floss in opposite directions such that the central portion of the floss forms an “X” in which lengths of the floss overlap to form a piece of dental floss 15D have the general configuration illustrated in FIG. 7.

When dental floss 15D is mounted on a tool or fork 10, the loop ends seat in detents 31 and 14 and the central knot or overlap or tie portion 18D is spaced away from and located intermediate arms 11 and 12. Consequently, when fork 10 is used to insert floss 15D between the interproximal mesial and distal surfaces of a pair of adjacent teeth, the central knot or overlap or tie portion 18D is positioned intermediate the interproximal mesial and distal surfaces and the legs of each loop diverge away from the central knot or overlap or tie portion 18B and tend to extend over and wrap around the interproximal mesial and distal and other tooth surfaces.

In use of tool 10, a piece of preformed dental floss 15, 15A, 15B, 15C is selected and mounted on the fork to tension arms 11 and 12 by drawing the arms 11, 12 closer together. The shorter the piece of dental floss that is selected, the greater the lateral displacement force that is produced on arms 11 and 12 when the piece of floss is mounted on the distal ends of the arms 11, 12; and, accordingly, the greater the tensile or “stretch” forces exerted on the piece of floss by resiliently bent arms 11 and 12. Tool 10 can, if desired, be mounted on a support member 30. The tool 10 is then used in conventional fashion to floss teeth, after which the dental floss 15, 15A, 15B, 15C is removed and discarded. The fork is retained for later use with a new piece of disposable preformed dental floss. One advantage of retaining and repeatedly using the fork is that pieces of dental floss 15, 15A, 15B, 15C can be easily and economically packaged in a sterile pack, either individually or in multiples. Further, such sterile packs can include medicaments or flavors in liquid or powder form. The medicaments can coat and/or penetrate the pieces of dental floss. Still further, since the fork is retained, it can, instead of the inexpensive polymer material utilized in current dental floss forks, be fabricated from a nickel-titanium alloy or other material more suitable to achieving the structure and functions of the tool 10 of the invention. In the presently preferred embodiment of the invention, tool 10 is not intended to be disposable, but is intended to be continuously used over and over with new, disposable, pieces 15, 15A, 15B, 15C of preformed dental floss.

In another embodiment of the invention a treatment regime is followed in which green floss (minimal abrasiveness) pieces of dental floss are, for example, utilized once or more daily. Orange floss (medium abrasiveness) is utilized once a week. Red floss (coarse abrasiveness) is utilized once a month. These usage rates can vary depending on the needs of a patient. For example, in some cases is may be desirable to use orange floss twice a week; or to use green floss only three times a week; or to use red floss once a week; and so on. Regardless, the idea of the treatment regime is to utilize more often during a period of time a first floss which has less abrasiveness than at least a second floss which is utilized less frequently during the same period of time. And, as noted, a third floss can be utilized during the same period of time which has greater abrasiveness than the second floss. The third floss is used less frequently than the second floss during the period of time. And, a fourth floss can be utilized during the same period of time which has greater abrasiveness than the third floss. The fourth floss is used less frequently than the third floss during the same period of time. And so on.

FIG. 8 illustrates another dental cleaning tool 50 that can be mounted on a support member 30. Tool 50 comprises the head of a toothbrush and includes base 52, handle 51 (only partially shown), and a plurality of resilient bristles 52 each fixedly attached to base 52. Each bristle 52 includes an outer tooth contacting and cleaning surface 59; a proximate end 54 fixedly attached to and extending outwardly from the base 52; and, an outer tooth contacting loop portion connected to the proximate end 54. The loop portion includes a first portion 55 extending upwardly in a first direction away from the proximate end 54 and from the base 52, and includes a second fold portion 56. Fold portion 56 is (1) connected to the first portion 55 and loops to extend in a second direction opposed to said first direction and generally toward the proximate end 54 and the base 52, (2) includes a downwardly extending leg 58 opposing and spaced apart from said first portion, and (3) includes an outer tooth contacting surface 59. The first and second portions circumscribe at least in part an open space 57 intermediate the first and second portions. When base 52 is manipulated to press surface 59 of a resilient bristle 53 against a tooth surface with sufficient force, bristle 53 is compressed and flatten. If bristle 53 is relatively soft and pliable, the compressive force required to flatten bristle 53 is minimal. If bristle 53 is relatively hard and stiff, the compressive force require to flatten bristle 53 is greater.

In FIG. 9, bristle 53 has a flat oval shape with edges 60. If desired, bristle 53 can have a rounded circular or oval shape akin to that of an O-ring, i.e., without edges 60.

FIG. 10 illustrates an alternate bristle design including an outer tooth contacting and cleaning surface 59A; a proximate end 54A fixedly attached to and extending outwardly from the base 52 of the head 50 of a toothbrush; and, an outer tooth contacting loop portion connected to the proximate end 54A. The loop portion includes a first portion 55A extending upwardly in a first direction away from the proximate end 54A and from the base 52, and includes a second fold portion 56A. Fold portion 56A is (1) connected to the first portion 55A and loops to extend in a second direction opposed to said first direction and generally toward the proximate end 54A and the base 52, (2) includes a downwardly extending leg 58A opposing and spaced apart from said first portion, and (3) includes an outer tooth contacting surface 59A. The first and second portions circumscribe at least in part an open space 57A intermediate the first and second portions.

FIG. 11 illustrates an alternate bristle design including an outer tooth contacting and cleaning surface 59B; a proximate end 54BA fixedly attached to and extending outwardly from the base 52 of the head 50 of a toothbrush; and, an outer tooth contacting loop portion connected to the proximate end 54B. The loop portion includes a first portion 55B extending upwardly in a first direction away from the proximate end 54B and from the base 52, and includes a second fold portion 56B. Fold portion 56B is (1) connected to the first portion 55B and loops to extend in a second direction opposed to said first direction and generally toward the proximate end 54B and the base 52, (2) includes a downwardly extending leg 58B opposing and spaced apart from said first portion, and (3) includes an outer tooth contacting surface 59B. The first and second portions circumscribe at least in part an open space 57B intermediate the first and second portions.

FIG. 12 illustrates an alternate bristle design including an outer tooth contacting and cleaning surface 59C; a proximate end 54C fixedly attached to and extending outwardly from the base 52 of the head 50 of a toothbrush; and, an outer tooth contacting loop portion connected to the proximate end 54C. The loop portion includes a first portion 55C extending upwardly in a first direction away from the proximate end 54C and from the base 52, and includes a second fold portion 56C. Fold portion 56C is (1) connected to the first portion 55C and loops to extend in a second direction opposed to said first direction and generally toward the proximate end 54C and the base 52, (2) includes a downwardly extending leg 58C opposing and spaced apart from said first portion, and (3) includes an outer tooth contacting surface 59C. The first and second portions circumscribe at least in part an open space 57C intermediate the first and second portions.

FIG. 13 illustrates an alternate bristle design including an outer tooth contacting and cleaning surface 59D; a proximate end 54D fixedly attached to and extending outwardly from the base 52 of the head 50 of a toothbrush; and, an outer tooth contacting loop portion connected to the proximate end 54D. The loop portion includes a first portion 55D extending upwardly in a first direction away from the proximate end 54D and from the base 52, and includes a second fold portion 56D. Fold portion 56D is (1) connected to the first portion 55D and loops to extend in a second direction opposed to said first direction and generally toward the proximate end 54D and the base 52, (2) includes a downwardly extending leg 58D opposing and spaced apart from said first portion, and (3) includes an outer tooth contacting surface 59D. The first and second portions circumscribe at least in part an open space 57D intermediate the first and second portions.

FIG. 14 illustrates an alternate bristle design including an outer tooth contacting and cleaning surface 59E; a proximate end 54E fixedly attached to and extending outwardly from the base 52 of the head 50 of a toothbrush; and, an outer tooth contacting loop portion connected to the proximate end 54E. The loop portion includes a first portion 55E extending upwardly in a first direction away from the proximate end 54E and from the base 52, and includes a second fold portion 56E. Fold portion 56E is (1) connected to the first portion 55E and loops to extend in a second direction opposed to said first direction and generally toward the proximate end 54E and the base 52, (2) includes a downwardly extending leg 58E opposing and spaced apart from said first portion, and (3) includes an outer tooth contacting surface 59E. The first and second portions circumscribe at least in part an open space 57E intermediate the first and second portions.

A bristle 53 with an oval, circular or other ovoid or rounded shape is presently preferred in the practice of the invention. Bristle 53 could, as would be appreciated by those of skill in the art, have a hexagonal, octagonal, etc. shape or any other desired shape. One presently preferred critical feature of the invention is that bristle 53 includes a tooth contacting surface 59 that folds or loops around in part a central open area 57.

Unless reasons exist to the contrary, judicial notice is taken of the following facts:
1. Millions of toothbrushes with straight, unitary bristles have been manufactured and sold for many years.
2. There are numerous issued patents illustrating toothbrushes with straight unitary bristles. The straight unitary bristles may be grouped together or spaced apart.
3. There are no patents illustrating toothbrushes with bristles that are not straight and unitary
4. A dominant long felt market trend exists in connection with a toothbrush. The trend comprises that fact that straight unitary bristles are utilized. This trend has occurred over an extended period of time, is followed by a large number of individuals in the pertinent art, and can be demonstrated by a significant number of references. A countervailing trend, if any, is believed to be much weaker or to be obfuscated among other trends in the art. Evidence of the dominant long felt trend includes:
   a. Millions of toothbrushes with straight, unitary bristles have been manufactured and sold.
   b. There is absolutely no evidence that a toothbrush that utilizes bristles that are not straight unitary bristles has been sold on the market.
5. Millions of dental floss dispensers comprising dental floss on a roll have been sold.
6. Millions of disposable forks with a strand of dental floss extending between a pair of arms have been sold.
7. A first dominant long felt market trend exists in connection with dental floss. The market trend comprises selling dental floss on wound rolls in dispensers. This trend has occurred over an extended period of time, is followed by a large number of individuals in the pertinent art, and can be demonstrated by a significant number of references. A countervailing trend, if any, to apply is believed to be much weaker or to be obfuscated among other trends in the art.
8. A second dominant long felt market trend exists in connection with dental floss. The market trend comprises selling dental floss strands permanently affixed to disposable forks. This trend has occurred over an extended period of time, is followed by a large number of individuals in the pertinent art, and can be demonstrated by a significant number of references. A countervailing trend, if any, to apply is believed to be much weaker or to be obfuscated among other trends in the art.
9. The fact that an invention is disclosed in a patent does not necessarily mean that the invention was successful in the relevant market.
10. Many patented or otherwise published inventions never reach the relevant market.
11. If a patented or published invention is not utilized in the relevant market, the patented invention may have no or little affect on market trends and/or may only comprise a subservient trend that is ignored by the members of the relevant market.
12. If a patented or published invention is not utilized in the relevant market, members of the relevant market may not, in reality, even be aware of the invention.
13. If a patented or published invention is not utilized in the relevant market, that may make it less likely that the invention provides any significant impetus toward developing a different invention disclosed in a pending patent application.
14. Common sense judgment requires that valid reasoning justifying such judgment be set forth.
15. There is no identified motivation or problem in the dental care art that provides significant impetus for the development of the invention. Conventional dental care methods have long been accepted.
16. There is no identified motivation or problem in the dental care art that suggests a readily apparent specific set of solutions, one of which is the invention. Conventional dental care methods have long been accepted.
17. There is no identified motivation or problem in the dental care art that suggests altering or adding to the conventional toothbrush and dental floss constructs. Conventional constructs have long been accepted.
18. The TSM test, per KSR, can provide helpful insight into evaluating the obviousness of the invention.
19. There is no reason not to use the TSM test in evaluating the obviousness of the invention described and claimed herein.
20. Making something better is a broad, general, long-existing motivation that applies to most, if not all, inventions. Broad, general, long-existing motivations likely provide little significant impetus to produce an invention. For example, in the exercise machine art, one broad, general, long-existing motivation is to make exercise machines versatile, so that more than one exercise can be produced on an exercise machine. This motivation may provide impetus to make obvious modifications to a machine, but provides little significant impetus to produce an invention. If, on the other hand, an exercise machine produces a greater than normal number of injuries, such a problem is more specific and provides stronger impetus to improve the machine.
21. One particular unexpected and unpredicted benefit discovered after the invention was developed is that the tool 10 reduces the risk that gums will be injured during flossing.
22. Definitions of common sense are set forth below, along with an indication of how the terminology “common sense” is utilized herein.

### A. The People in Common (PIC) Definition: “The Earth is Flat”.

One definition of common sense is what people in common would agree upon, that which they “sense” as their common natural understanding or would consider in most people's experience to be prudent and of sound judgment. This definition assumes a country with a population with a particular baseline language, customs and knowledge. The baseline knowledge is knowledge available and known by a large majority of the population, and is knowledge that typically does not require specialized knowledge or study; such baseline knowledge can change over time depending on the success of educational institutions, changing societal climes, etc. Under the people in common (PIC) definition, common sense often has been wrong and, for example, at one time held that the earth was flat. Even today it evidently is estimated that 60% of the people on earth believe the sun revolves around the earth. Others today use common sense to make the judgment that heavier bodies fall faster than light bodies.

### B. The Common Man Sound Judgment (CMSJ) Definition.

A second definition of common sense is sound judgment based on a simple perception of the situation or facts. Sound judgment means sensible judgment based on valid reasoning. This suggests that a common sense judgment, if reliable, is subject to evaluation to see if there are reasons or criteria that support and justify the judgment. This definition assumes a country with a population with a particular baseline language, customs and knowledge. The baseline knowledge is knowledge available and known by a large majority of the population, and is knowledge that typically does not require specialized knowledge or study; such baseline knowledge can change over time depending on the success of educational institutions, changing societal climes, etc. What might be common sense to an American might not be common sense to a person living in another country. An individual could move to the United States from India and what might appear common sense to an American would, because of the culture of India, make absolutely no sense to the Indian. In evaluating obviousness, however, it is usually, for better or worse, assumed that the Indian has the same baseline knowledge as individuals who have grown up in the United States.

### C. The Ordinary Skill Sound Judgment (OSSJ) Definition.

A third definition of common sense is sound judgment by one of ordinary skill in the art based on a perception of the situation or facts in the context of the baseline knowledge in CMSJ and of specialized knowledge that is over and above said baseline knowledge and is attributed to one of ordinary skill in the art. As noted, sound judgment means sensible judgment based on valid reasoning. This suggests that a common sense judgment by one or ordinary skill in the art is, if reliable, subject to evaluation to see if there are reasons or criteria that support and justify the judgment. This definition assumes a country with a population with a particular baseline language, customs and knowledge. The baseline knowledge and specialized knowledge comprise knowledge available and known by a large majority of those of skill in the art; such baseline knowledge and specialized knowledge can change over time depending on the success of educational institutions, advances in the art, changing societal climes, etc. What might be common sense to an American of ordinary skill in the art might not be common sense to a person that lives in another country and appears to be one of ordinary skill in the art. In evaluating obviousness, however, it is usually, for better or worse, assumed that the person of ordinary skill in the art from India has the same baseline knowledge as individuals of skill in the art who have grown up in the United States. In some technically simple inventions, the ordinary skill sound judgment (OSSJ) may be commensurate with common man sound judgment (CMSJ) because there is little if any specialized knowledge required. For example, a new Christmas tree ornament design might not require any particular specialized knowledge over and above the baseline knowledge of the large majority of people. In contrast, many inventions obviously require a specialized knowledge over and above commonly held baseline knowledge, in which case such specialized knowledge will be utilized in the sound reasoning involved in ordinary skill sound judgment common sense.

As used herein, relying on common sense judgment requires that valid reasoning justifying such judgment be set forth. Hence, the common man sound judgment (CMSJ) and ordinary skill sound judgment (OSSJ) definitions are generally relied on herein with respect t determining the obviousness of an invention. Further, in evaluating the obviousness of the invention it is believed some specialized knowledge over and above the baseline knowledge is required; namely, at least some knowledge in connection with the construction and use of dental care apparatus comprising toothbrushes and dental floss. CMSJ and OSSJ common sense do not appear reasonably to suggest the invention.
23. Trends. As used herein a trend is a general inclination or tendency. A trend generally (1) occurs over an extended period of time, (2) occurs by or within a large number of individual in the pertinent art, and (3) is demonstrated by a significant number of references. With respect to (1) above in this paragraph, a general inclination that last a short period of time, for example a day or a month, typically does not constitute a trend. With respect to (2) above in this paragraph, if only a few individuals demonstrate a general inclination or tendency, thus such typically does not comprise a trend. With respect to (3) above in this paragraph, if there are only a few documents that demonstrate a particular inclination or tendency, such typically does not demonstrate a trend.

The weight or importance of a trend in leading to an invention is evaluated by (1) evaluating the length of time during which the trend has existed, (2) the number of individuals that believed or followed the trend, (3) the number of references that describe the trend, (4) the existence of other similar or related trends that might obfuscate a trend and make it unlikely to lead to the invention, and (5) the existence of countervailing trends. If a trend is “buried” among many comparable trends in the art, it becomes more unlikely that one of ordinary skill will notice or utilize the trend. If a trend is overshadowed by countervailing trends, it becomes more unlikely that one of ordinary skill will notice of utilize the trend. There appears to be no reasonable explanation of some trend that would lead to the invention. There appears to be no market need or trend directing a particular solution in such respects, much less somehow suggesting the invention.
24. Equivalents. As used herein, an equivalent is a structure or a system that is functionally or structurally equivalent to another structure or system. In determining whether it is obvious to substitute one “equivalent” for another, the following must be evaluated. First, is what is being substituted truly an equivalent? Is it functionally or structurally equivalent to what is being replaced? Second, if the equivalent is functionally or structurally equivalent, is it only structurally equivalent or only functionally equivalent? If it is only one or the other, this reduces the likelihood the equivalent would be used. Third, did the equivalent, or the invention, have to be modified to use the equivalent? If so, this reduces the likelihood the equivalent would be utilized. Fourth, is it likely the equivalent would be considered by one of ordinary skill in the art? If a new Christmas ornament utilizes a laminate including an outer protection coating from a prior Christmas ornament and substitutes that coating as an “equivalent” for the outer protective coating in another known Christmas ornament, then it arguably is likely that such a substitution would be considered by one of skill in the art. On the other hand, if the first substitute coating is normally found in a nuclear reactor in a submarine, it may be very unlikely, almost incredible, that such a coating would be considered and a substitution would be made. Simply stating that it would be known by one of skill in the art to substitute an equivalent is not, without providing reasons, believed sufficient. Otherwise such a generalized rationale could be used to invalidate most, if not all, patents known to man.
25. Importance of Problem or Motivation. The weight or importance of a problem or motivation in leading to an invention is apprised by evaluating by (1) how long the problem has existed, (2) the importance, and hence the driving force, of the problem or motivation, (3) whether the problem or motivation reasonably suggests the invention, (4) whether the motivation reasonably suggests a set of solutions of which the invention is one, (5) the trends, if any, produced by the problem or motivation, and (6) other solutions produced in response to the motivation or problem. With respect to (1) above in this paragraph, if a problem has long existed without producing a solution, that suggests the invention is not obvious. With respect to (2) above in this paragraph, if the problem appears to have little significance, that suggests it is not driving those of skill in the art toward the invention. With respect to (3) above, if the problem suggests a solution other than the invention, this suggests the problem is not driving those of skill in the art toward the invention. With respect to (4) above in this paragraph, if the problem suggests a set of solutions other than the invention, this suggest the problem is not leading toward the invention. With respect to (5) above, if the prevailing trends lead away from the invention or reinforce other solutions to the invention, that suggest the problem has not presented the invention as a solution. With respect to (6) above in this paragraph, other solutions may reinforce the idea that the art is satisfied with the status quo and not interested in alternate solutions.

Having described my invention in such terms as to enable those of skill in the art to understand and practice it, and having described the presently preferred embodiments thereof, I claim:

1. A method to clean the interproximal mesial and distal surfaces of a pair of adjacent teeth, comprising the steps of
(a) providing at least first and second preformed disposable pieces of dental floss each having a selected generally fixed length and a pair of ends;
(b) providing a dental cleaning tool including a handle and a reusable fork having at least a pair of resilient spaced apart arms, each arm having a distal end with a detent formed therein to receive at least one of said ends of each of said pieces of dental floss, each of said ends of each piece of said dental floss shaped and dimensioned to seat removably in at least one of said detents, said arms
(i) movable between at least two operative positions,
a first untensioned position without one of said pieces of dental floss mounted on and extending therebetween, the distance between said arms in said first position being greater than said length of each of said pieces of dental floss, and
a second tensioned position with
one of said pieces of floss mounted on said fork,
each of said ends of said one of said pieces of dental floss seated in a different one of said detents,
at least one of said arms pulled toward the other by said one of said pieces of dental floss to tension said arms,
(ii) spaced apart a distance in the range of twelve mm to fifty mm in the second tensioned position, and
(iii) displaced toward each other a distance of at least three mm when a shear force in the range of fifty to two thousand grams is exerted against one of said pieces of dental floss after one of said pieces of dental floss is mounted on said fork and said legs in said second tensioned position;
(c) moving said legs from said first untensioned position to said second tensioned position by mounting said first piece of dental floss on said legs of said fork with each end of said first piece seated in a different one of said detents;
(d) manually grasping said handle and manipulating said tool to move said first piece of dental floss mounted on said fork between the pair of adjacent teeth to generate a shear force in the range of fifty to two thousand grams to displace said arms toward each other a distance of at least three millimeters;
(e) removing said first pieces of dental floss from said fork;
(f) mounting said second piece of dental floss on said legs of said fork with each end of said second piece of dental floss seated in a different one of said detents; and,
(g) manually grasping said handle and manipulating said second piece of dental floss over the interproximal mesial and distal surfaces of the pair of adjacent teeth.

2. The method of claim 1 wherein in step (a) said first piece of dental floss has a length different than said second piece of dental floss.

3. The method of claim 1 wherein in step (a) said pieces of preformed dental floss are each looped at either end and generally have the shape of a figure eight.

4. A method to clean teeth, comprising the steps of
(a) providing a toothbrush including
(i) a handle,
(ii) a head,
(iii) a plurality of resilient elongate bristles each including
a proximate end fixedly attached to said head,
an outer tooth contacting loop portion connected to said proximate end and including
a first portion extending upwardly in a first direction away from said proximate end and said head, and
a second fold portion
connected to said first portion and looping to extend in a second direction opposed to said first direction and generally toward said proximate end and said head,
including a downwardly extending leg opposing and spaced apart from said first portion,
including an outer tooth contacting surface,
said first and second portions circumscribing at least in part an open space intermediate said first and second portions; and,
(b) grasping said handle and contacting and brushing teeth with said outer tooth contacting surfaces of said bristles.
